(19) United States
(12) Patent Application Publication
(10) Pub. No.: US 2025/0344155 A1
(43) Pub. Date: Nov. 6, 2025

(54) USER EQUIPMENT AND METHOD OF LOW POWER WAKE UP SIGNAL PROCEDURE

(71) Applicant: SHENZHEN TCL NEW TECHNOLOGY CO., LTD., Shenzhen, Guangdong (CN)

(72) Inventor: Shahid JAN, Shenzhen, Guangdong (CN)

(73) Assignee: SHENZHEN TCL NEW TECHNOLOGY CO., LTD., Shenzhen, Guangdong (CN)

(21) Appl. No.: 19/126,238

(22) PCT Filed: Nov. 4, 2022
(86) PCT No.: PCT/CN2022/129931

§ 371 Date: Apr. 30, 2025

(51) Int. Cl. H04W 52/02; H04W 68/02; H04W 72/23; H04W 72/30

(52) U.S. Cl. CPC H04W 52/0235; H04W 68/02; H04W 72/23; H04W 72/30

(57) ABSTRACT

A method of low power wake up signal (LP-WUS) procedure includes waking up a main radio of the UE, by a low power wake up receiver (LP-WUR) of a user equipment (UE), using a LP-WUS, wherein a signal design of the LP-WUS comprises a sequence based signal design with a physical broadcast channel (PBCH) and/or a UE specific/UEs group specific based signal design of the LP-WUS.

### BACKGROUND OF DISCLOSURE

### 1. Field of the Disclosure

The present disclosure relates to the field of wireless communication systems, and more particularly, to a user equipment (UE) and a method of low power wake up signal (LP-WUS) procedure in 5G NR (new radio) communication system. More specifically, the present disclosure discusses the signal design and procedure of LP-WUS and low power wake up receiver architecture (LP-WUR), in order to define an ultra-low power mechanism for UE to enhance the UE power saving.

### 2. Description of the Related Art

Energy efficiency is one of the basic requirements of 5G system due its support of diverse use cases including power sensitive devices such as IoT (industrial wireless sensors, controllers), wearables etc. The power consumption of these devices depends on the configured length of wake-up periods, e.g., paging cycle. To meet the battery life requirements, eDRX cycle with large value is expected to be used, resulting in high latency, which is not suitable for such services with requirements of both long battery life and low latency. For instance, in fire detection and extinguishment use case, fire shutters shall be closed, and fire sprinklers shall be turned on by the actuators within 1 to 2 seconds from the time the fire is detected by sensors, thus long eDRX cycle cannot meet the delay requirements. eDRX is apparently not suitable for latency-critical use cases. In DRx and eDRx cycle, the UEs need to periodically wake up once per DRX cycle, which dominates the power consumption in periods with no signaling or data traffic. If UEs are able to wake up only when they are triggered, e.g., paging in idle/inactive state and PDCCH in connected state, power consumption could be dramatically reduced. This can be achieved by using a wake up signal to trigger the main radio and a separate receiver which has the ability to monitor the wake up signal with ultra-low power consumption as mentioned by the following objectives of the study item description (SID): Primarily target low-power WUS/WUR for power-sensitive, small form-factor devices including IoT use cases (such as industrial sensors, controllers) and wearables. Study and evaluate wake-up signal designs to support wake-up receivers [RAN1, RAN4]. Study potential UE power saving gains compared to the existing Rel-15/16/17 UE power saving mechanisms and their coverage availability, as well as latency impact. System impact, such as network power consumption, coexistence with non-low-power-WUR UEs, network coverage/capacity/resource overhead should be included in the study [RAN1]. In addition, the low power wake up signal (LP-WUS) also focus on the low latency requirements e.g. lower than eDRX latency to support diverse use cases.

In prior art, several companies proposed on-off keying (OOK) and frequency shift keying (FSK) based waveform for LP-WUS signals, sequence based and message based signals design to carry the information for the UE main radio to wake up, and define the procedures of LP-WUS monitoring. However, most of the companies paid no attention to the latency, low complexity of LP-WUR, and synchronization of LP-WUR related issues. Therefore, there is a need to further study a detail mechanism of LP-WUS and take into account the latency, synchronization, and low complexity of LP-WUR architecture in the signal design and working procedure of LP-WUS.

### SUMMARY

An object of the present disclosure is to propose a user equipment (UE) and a method of low power wake up signal (LP-WUS) procedure, to study a detail mechanism of LP-WUS and take into account the latency, synchronization, and low complexity of LP-WUR architecture in the signal design and working procedure of LP-WUS.

In a first aspect of the present disclosure, a method of low power wake up signal (LP-WUS) procedure includes waking up a main radio of the UE, by a low power wake up receiver (LP-WUR) of a user equipment (UE) using a LP-WUS, wherein a signal design of the LP-WUS comprises a sequence based signal design with a physical broadcast channel (PBCH) and/or a UE specific/UEs group specific based signal design of the LP-WUS.

In a second aspect of the present disclosure, a method of LP-WUS procedure includes waking up a main radio of the UE, by a low power wake up receiver (LP-WUR) of a user equipment (UE) using a periodic LP-WUS and/or a configured LP-WUS.

In a third aspect of the present disclosure, a user equipment comprises a memory, a transceiver, and a processor coupled to the memory and the transceiver. The processor is configured to perform the above method.

In a fourth aspect of the present disclosure, a non-transitory machine-readable storage medium has stored thereon instructions that, when executed by a computer, cause the computer to perform the above method.

In a fifth aspect of the present disclosure, a chip includes a processor, configured to call and run a computer program stored in a memory, to cause a device in which the chip is installed to execute the above method.

In a sixth aspect of the present disclosure, a computer readable storage medium, in which a computer program is stored, causes a computer to execute the above method.

In a seventh aspect of the present disclosure, a computer program product includes a computer program, and the computer program causes a computer to execute the above method.

In an eight aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating an example of LP-WUR in IEEE.

FIG. 2 is a schematic diagram illustrating an example of LP-WUS and PEI triggers of the main radio.

FIG. 3 is a schematic diagram illustrating an example of main radio ON time triggered by LP-WUS.

FIG. 4 is a block diagram of one or more user equipments and a network/gNB of communication in a communication network system according to an embodiment of the present disclosure.

FIG. 5 is a flowchart illustrating a method of low power wake up signal (LP-WUS) procedure according to an embodiment of the present disclosure.

FIG. 6 is a schematic diagram illustrating an example of sequence base design of LP-WUS with PBCH according to an embodiment of the present disclosure.

FIG. 7 is a schematic diagram illustrating an example of UE specific or UE group specific design of LP-WUS according to an embodiment of the present disclosure.

FIG. 8 is a schematic diagram illustrating an example of LP-WUS with longer periodicity according to an embodiment of the present disclosure.

FIG. 9 is a schematic diagram illustrating an example of LP-WUS with shorter periodicity according to an embodiment of the present disclosure.

FIG. 10 is a schematic diagram illustrating an illustration of configured LP-WUS to trigger the main radio for PEI monitoring according to an embodiment of the present disclosure.

FIG. 11 is a schematic diagram illustrating an illustration of configured LP-WUS to trigger the main radio for paging PDCCH according to an embodiment of the present disclosure.

FIG. 12 is a schematic diagram illustrating an illustration of LP-WUS monitoring procedure in connected state according to an embodiment of the present disclosure.

FIG. 13 is a schematic diagram illustrating an illustration of configured LP-WUS trigger the main radio for PDDCH monitoring in DRx on duration according to an embodiment of the present disclosure.

FIG. 14 is a schematic diagram illustrating an illustration of periodic LP-WUS to trigger the main radio in DRx off Duration according to an embodiment of the present disclosure.

FIG. 15 is a schematic diagram illustrating an illustration of configured LP-WUS to trigger the main radio in DRx on Duration according to an embodiment of the present disclosure.

FIG. 16 is a schematic diagram illustrating an illustration of configured LP-WUS to trigger the main radio in DRx off duration according to an embodiment of the present disclosure.

FIG. 17 is a block diagram of a UE for wireless communication according to an embodiment of the present disclosure.

FIG. 18 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

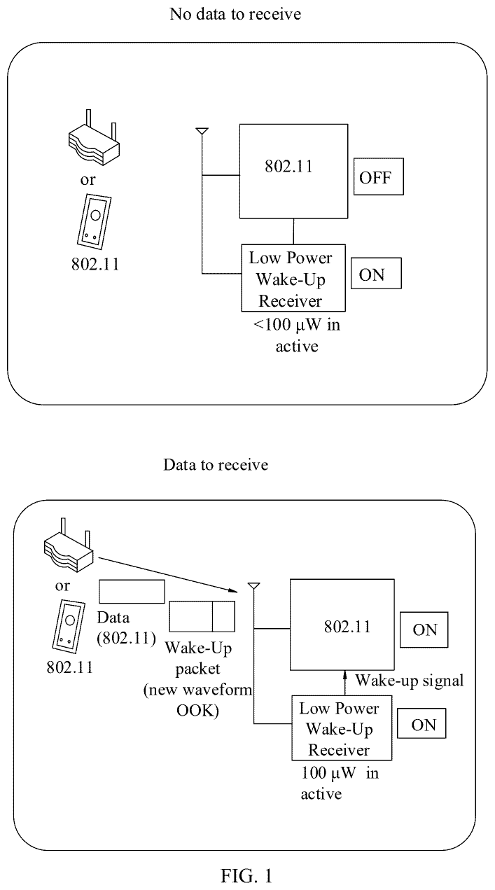

The basic procedure and working principle of LP-WUS and LP-WUR is illustrated in FIG. 1, where the main radio is used for data transmission and reception only, which can be turned OFF or set to deep sleep unless it is turned on, while the low power wake up receiver (LP-WUR) stays ON to monitor the wake up signals. The illustration diagram of LP-WUS and LP-WUR is based on the IEEE low power receiver architecture, and it can be considered as a baseline to design the LP-WUS procedure and LP-WUR architecture for 3GPP cellular network.

The key requirement of Rel-18 ultra-low power consumption mechanism is to allow the main radio of a UE to sleep for long time and wake up only when it is triggered by the network, in both idle/inactive and connected states. A similar mechanism of power saving is introduced in Rel-16 in terms of wake up signals (WUS) for connected state UE, and in Rel-17 in terms of paging early indication (PEI) for idle/inactive state UE, where both procedures are used to trigger the receiver of a UE before PDCCH monitoring and paging occasion, respectively. However, these legacy mechanisms directly trigger the main receiver as compared to Rel-18 LP-WUS mechanism, and thus consume more power. On the other hand, the LP-WUS can be used to trigger the main radio of UE only when it has to receive the data or signaling from the network/gNB in both idle/inactive and connected states.

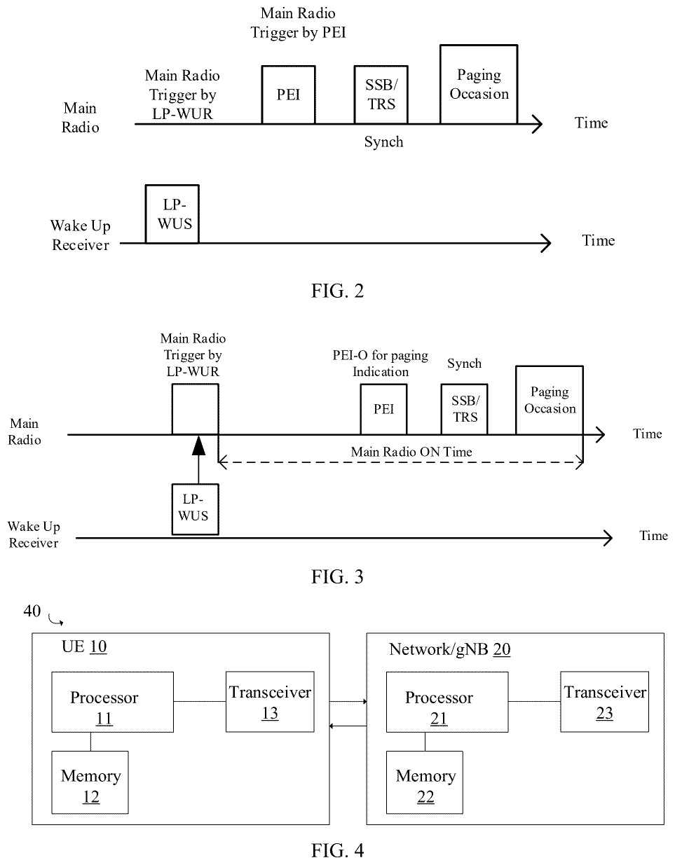

However, the transmission of LP-WUS in idle/inactive state may trigger the LP-WUR by two times to wake up, such as one time by LP-WUS and one time by PEI as shown in FIG. 2. This mechanism may consume more UEs power as compared to the Rel-17 PEI based power saving mechanism. In addition, in case the LP-WUS is transmitted very early in time domain to trigger the main radio before PEI, the main radio may stay on for long time, which may increase the UE power consumption as shown in FIG. 3.

In addition, due to the low cost LP-WUR architecture, the LP-WUR receiver sensitivity may not be able to detect the LP-WUS to trigger the main radio, when data/signaling are transmitted by the network/gNB, and thus the LP-WUR architecture does not satisfy the LP-WUS coverage requirements, especially for those UEs which are located in cell edge areas. This miss detection of LP-WUS may direct the main radio to stay in sleeping mode which leads the UE to miss the transmission or reception of the data and signaling. Therefore, it is necessary to study further the coverage enhancement methods of LP-WUS to avoid the data or signaling miss detection by the main radio.

The main objective of some embodiments of this invention is to define and develop an ultra-low power mechanism of LP-WUS with focus on low latency, low overhead and LP-WUR synchronization with the network. The proposed solutions to achieve our objectives are summarized as below.

Two different signal designs of LP-WUS are proposed as given below. 1. Sequence based signal design of LP-WUS with physical broadcast channel (PBCH) has proposed to broadcast the LP-WUS to all the UEs under the cell coverage to trigger the main radio for wake up. 2. UE specific and UEs group specific based LP-WUS signal design is proposed, which can achieve the latency requirements of latency critical services.

Two alternative working mechanisms of LP-WUS procedure have been proposed for both idle/inactive and connected states as given below. 1. Periodic LP-WUS working mechanism is proposed to reduce the LP-WUS overhead, its decoding complexity and support low cost LP-WUR architecture. 2. Configured LP-WUS working mechanism is proposed to achieve the strict requirements of latency sensitive services.

Some embodiments of this disclosure discuss the signal design and procedure of LP-WUS in both idle/inactive state and connected states and have the following one or more advantages: ultra-low power consumption mechanism, low overhead, low latency, and LP-WUS coverage enhancement.

FIG. 4 illustrates that, in some embodiments, one or more user equipments (UEs) 10 and a network/gNB 20 for communication in a communication network system 40 according to an embodiment of the present disclosure are provided. The communication network system 40 includes one or more UEs 10 and a network/gNB 20. The one or more UEs 10 may include a memory 12, a transceiver 13, and a processor 11 coupled to the memory 12 and the transceiver 13. The network/gNB 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

FIG. 5 illustrates a method 500 of low power wake up signal (LP-WUS) procedure according to an embodiment of the present disclosure. In some embodiments, the method 500 includes: a block 502, waking up a main radio of the UE, by a low power wake up receiver (LP-WUR) of a user equipment (UE), using a LP-WUS, wherein a signal design of the LP-WUS comprises a sequence based signal design with a physical broadcast channel (PBCH) and/or a UE specific/UEs group specific based signal design of the LP-WUS. Further, the processor 11 is configured to perform the above method 400. The processor 11 is also configured to perform the method in the following some embodiments.

In some embodiments, in the sequence based signal design with the PBCH, the LP-WUS is a sequence based LP-WUS, the information is broadcasted to multiple UEs through the sequence based LP-WUS, and an amount of the information transmitted in the sequence based LP-WUS to the multiple UEs have a pre-defined length, where a single bit information is assigned to the UE for wake up function and/or stay in sleeping mode function of the main radio of UE. In some embodiments, in the sequence based signal design with the PBCH, a length of the information transmitted to the UE in the sequence based LP-WUS depends on a number of UEs entered into a LP-WUS mode, and the length of the information is changed according to the number of UEs in the LP-WUS mode.

In some embodiments, in the sequence based signal design with the PBCH, the UE detects an allocated information based on its allocated symbols, which is assigned by the base station to the UE when the UE is entering into an LP-WUS mode. In some embodiments, in the UE specific/UEs group specific based signal design of the LP-WUS, the LP-WUS is a UE specific/UEs group specific based LP-WUS, and the UE specific/UEs group specific based LP-WUS is configured to the UE or a group of UEs, where the signal design comprises a low power synchronization signal (LP-SS), the WUS message part, and the payload. In some embodiments, the LP-SS synchronizes the LP-WUR before receiving a WUS message part, the WUS message part comprises a bit trigger information for the UE or the group of UEs and a payload comprising a UE identifier (ID) or a UE group ID for which the LP-WUS is transmitted.

In some embodiments, the UE specific/UEs group specific based LP-WUS is transmitted only to the UEs which need to wake up, and a single bit information is assigned to the UE for wake up function and/or stay in sleeping mode function of the main radio of UE. In some embodiments, when the main radio of UE is in a radio resource control (RRC) idle/inactive state, a transmission is initiated by a network/gNB to the UE through a paging occasion, and the LP-WUS is used as a trigger before the paging occasion, to activate the main radio of the UE or a group of UEs for monitoring of the paging occasion. In some embodiments, when the main radio of UE is in an RRC connected state, the main radio is on while a PDCCH monitoring is performed based on the detection of LP-WUS. In some embodiments, the LP-WUS is used to indicate whether to enter a discontinuous reception (DRX) on state, and/or the LP-WUS is used in on-duration to indicate a start of the PDCCH monitoring.

In some embodiments, a periodic LP-WUS transmitted by the network/gNB is used by the LP-WUR of UE to trigger the main radio of the UE for paging monitoring or the LP-WUS is configured in specific occasion to trigger the main radio of the UE for paging in the RRC idle/inactive state or the RRC connected state. In some embodiments, the UE or a group of UEs uses the LP-WUS to trigger the main radio according to the sequence based signal design with the PBCH, and the LP-WUR of the UE or the group of UEs uses the periodic LP-WUS to trigger main radios of UEs only when a paging early indication (PEI) or a paging physical downlink control channel (PDCCH) for specific UEs is transmitted by the network/gNB. In some embodiments, the periodic LP-WUS is not UE specific or UEs group specific and the LP-WUS is broadcasted by the network/gNB in a cell or the LP-WUS is transmitted in different beams direction. In some embodiments, a periodicity of the periodic LP-WUS is defined in a range of {5, 10, 20, 40, 80, 160} milliseconds according to a periodicity of the 5G new radio (NR) SS burst. In some embodiments, the LP-WUR of the UE uses the LP-WUS to trigger the main radio which is near to the PEI in time domain. In some embodiments, a configured LP-WUS is used as an indication to inform the UE or the group of UEs to monitor a target paging PDCCH and replace the PEI for paging indication.

In some embodiments, when the main radio of UE is in an RRC connected state, the main radio is on while a PDCCH monitoring is performed based on the detection of LP-WUS. In some embodiments, the LP-WUS is used to indicate whether to enter a discontinuous reception (DRX) on state, and/or the LP-WUS is used in on-duration to indicate a start of the PDCCH monitoring. In some embodiments, the UE or a group of UEs uses the periodic LP-WUS to trigger the main radio according to the sequence based signal design with the PBCH, and the LP-WUR of the UE or the group of UEs uses the periodic LP-WUS to trigger main radios of UEs and indicates to enter a DRX on state to monitor a physical downlink control channel (PDCCH) in DRx on duration and/or DRx off duration. In some embodiments, the UE or a group of UEs uses the configured LP-WUS to trigger the main radio according to the LP-WUS signal design of UE specific or UEs group specific, and the LP-WUR of the UE or the group of UEs uses the configured LP-WUS to trigger the main radios of UEs and indicates to enter a DRX on state to monitor a physical downlink control channel (PDCCH) in DRx on duration and/or DRx off duration.

This disclosure discusses the signal design and procedure of low power wake up signals (LP-WUS) with focus on low power mechanism of UE in RRC idle/inactive state and RRC connected state. Embodiment 1 explains the signal design of LP-WUS with focus on low overhead and low complexity of low power wake up receiver (LP-WUR) architecture. Embodiment 2 focus on LP-WUS procedure and explains periodic LP-WUS and configured LP-WUS in RRC idle/inactive states. Embodiment 3 focus on LP-WUS procedure and explains periodic LP-WUS and configured LP-WUS in RRC connected states.

### Embodiment 1: Signal Design of LP-WUS

This embodiment of the present disclosure discusses the LP-WUS signal design. According to the objectives of the SID in the background description, the LP-WUS shall be designed with low power consumption as a primary feature, to simplify the detection procedure at the UE receiver side and support the low complexity LP-WUR architecture. In this disclosure we propose the following two design of LP-WUS.

### Embodiment 1.1: Sequence Based Signal Design with Physical Broadcast Channel

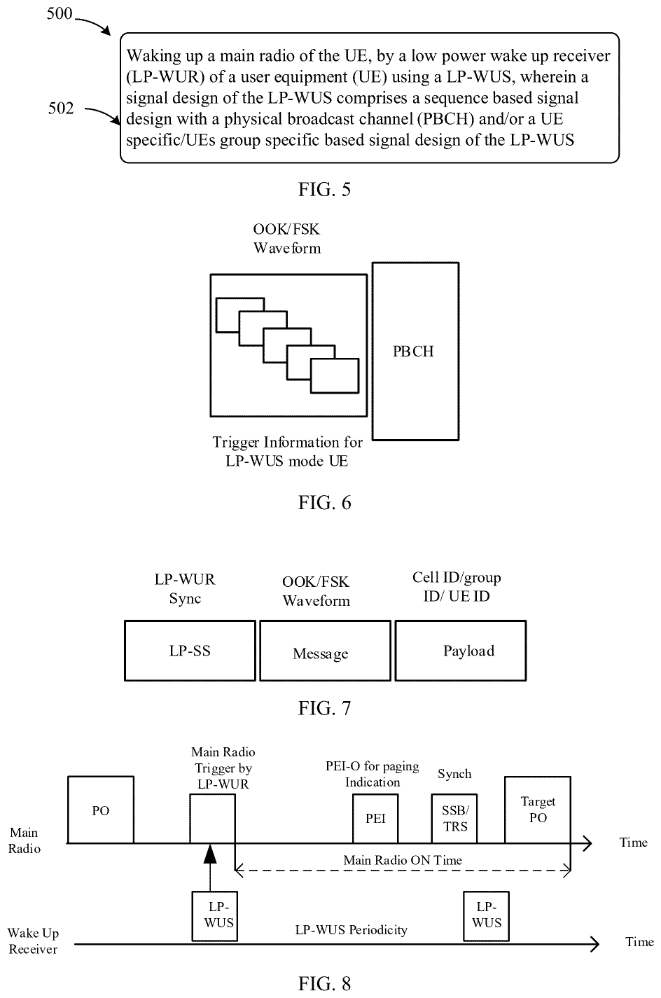

FIG. 6 is a schematic diagram illustrating an example of sequence base design of LP-WUS with PBCH according to an embodiment of the present disclosure. A sequence based design can be used with Physical broadcast channel to broadcast the information to multiple UEs through LP-WUS as shown in FIG. 6. The amount of information transmitted in sequence based LP-WUS to multiple UEs may have a pre-defined length, where a single bit information is assigned to UE for ‘wake up’ and/or ‘stay in sleeping mode’ functions of the main radio of UE. The UE can detect the allocated information implicitly based on its allocated symbols. In this signal design, a UE should be allocated a specific symbol in time domain in the sequence of length X, when it enters into the LP-WUS mode, and based on that specific symbol location in the sequence of length X, the LP-WUR of UE can implicitly detect its allocated symbol in the transmitted sequence and trigger the main radio according to the information detected.

For instance, an information of bit ‘0’ transmitted in the sequence of LP-WUS represent ‘stay in sleeping mode’ and an information of bit ‘1’ represents ‘wake up’. Based on this information, the LP-WUR of UE can wake up the main radio when the information for that specific UE is ‘1’ and let the main radio of a UE in sleeping when the information for that specific UE is ‘0’. In addition, the length of the information transmitted to the UE in the sequence based LP-WUS depends on the number of UEs entered into the low power WUS mode, and it can be changed according to the number of UEs in the LP-WUS mode.

Advantage: The detection mechanism of the sequence based LP-WUS signal with PBCH design is easy and the overhead of each UE LP-WUS is very low. For information transmission a simple OOK based waveform or FSK based waveform can be used. Since the sequence based LP-WUS with PBCH is broadcasted therefore UE ID/UEs group ID or UEs cell ID are not needed, which reduce the overhead of the LP-WUS signal design, and thus the low cost LP-WUR architecture can be used.

Disadvantage: A sequence-based design with PBCH might increase the amount of information when a greater number of UEs enters into the LP-WUS mode, thus it may increase the overall overhead of the LP-WUS on the network side.

### Embodiment 1.2: UE Specific/UEs Group Specific Based Signal Design of LP-WUS

FIG. 7 is a schematic diagram illustrating an example of UE specific or UE group specific design of LP-WUS according to an embodiment of the present disclosure. A UE specific/UEs group specific based LP-WUS can be configured to a UE or a group of UEs, where the signal design includes an LP-SS to synchronize the LP-WUR before receiving a WUS message part. The WUS message part can include a bit trigger information for a UE or a group of UEs and a payload which includes the UE ID or UE group ID for which the LP-WUS is transmitted as shown in FIG. 7. The UE specific/UEs group specific LP-WUS can be transmitted only to those UEs which needs to wake up. Similar to the sequence based signal the bit ‘0’ represents ‘stay in sleeping mode’ and bit ‘l’ represents ‘wake up’ functions of the main radio.

Advantages: The UE specific/UEs group specific based LP-WUS design reduces the amount of information which is carried to trigger the main radio of UE or group of UEs, and it can be transmitted only to those UEs which needs to be triggered by the network for data or signaling transmission/reception.

Disadvantage: This signal design carries the additional payload of UE ID/UE group ID which increase the complexity of LP-WUR for the UE ID/UE ID decoding and thus increase the LP-WUR power consumption. In addition, this signal design may also require synchronizing the LP-WUR of UE with the network before decoding the main radio trigger information.

### Embodiment 2: LP-WUS Procedure in Idle/Inactive State

In idle/inactive state, the network/gNB initiates a transmission to a UE through paging, therefore the LP-WUS can be used as a trigger before the paging occasion, to activate the main radio of a UE or a group of UEs for monitoring of paging occasion. This embodiment of the present disclosure proposes that the network/gNB can transmit periodic LP-WUS to trigger the main radio of a UE for paging or the LP-WUS can be configured in specific occasion to trigger the main radio of UE for paging in RRC idle/inactive state as explained below.

### Embodiment 2.1: Periodic LP-WUS

This embodiment of the present disclosure proposes periodic LP-WUS, which is transmitted by the network to trigger the main radio of a UE or a group of UEs for paging monitoring. For the periodic LP-WUS this disclosure assumed that a UE or group of UEs will use the LP-WUS to trigger the main radio according to the sequence based LP-WUS design with PBCH as explained in embodiment 1.1. In other words, the LP-WUR of a UE or group of UEs will use LP-WUS to trigger the main radio of UEs only, when the gNB transmit a PEI or paging PDCCH for that specific UEs. In addition, the periodic LP-WUS is not UE specific or UEs group specific and a gNB can broadcast LP-WUS in cell or it can be transmitted in different beams direction e.g. beam specific.

The following are the main advantages of periodic LP-WUS: 1. The periodic LP-WUS allows the availability of LP-WUS to each UE which is required to be triggered by the network, thus it enhances the LP-WUS coverage. 2. The periodic LP-WUS reduces the complexity of LP-WUR by not including the UE ID or UEs group ID in the LP-WUS.

### Periodicity of Periodic LP-WUS

The periodicity of periodic LP-WUS can be define in the range of {5, 10, 20, 40, 80, 160} milliseconds according to the periodicity of the 5G NR SS burst. In other words, the gNB can adjust the periodicity of LP-WUS in the range of {5, 10, 20, 40, 80, 160} milliseconds in order to select an appropriate periodicity by taking in account; the ON time of the main radio and the latency requirements of the transmission. In the following embodiments, we analyze the power consumption, latency, and network overhead of longer and shorter periodicity of the LP-WUS.

### Longer Periodicity of LP-WUS

FIG. 8 is a schematic diagram illustrating an example of LP-WUS with longer periodicity according to an embodiment of the present disclosure. LP-WUS with longer periodicity is beneficial in reducing the network overhead, however it may increase the ON time of the main radio, thus increases the power consumption of the main radio as shown in FIG. 8. In addition, the longer periodicity of LP-WUS will compels the main radio of UE to wait for the LP-WUS trigger to monitor PEI or paging PDCCH and the UE may miss the detection of PEI or paging PDCCH in one occasion and needs to perform the PEI or paging PDCCH monitoring in the next occasion.

Thus, the LP-WUS with longer periodicity increases the latency. Note: Here we assume that the LP-WUR of a UE will use the LP-WUS to trigger the main radio which is near to the PEI in time domain in order to reduce the main radio ON time and reduce the power consumption.

### Shorter Periodicity of LP-WUS

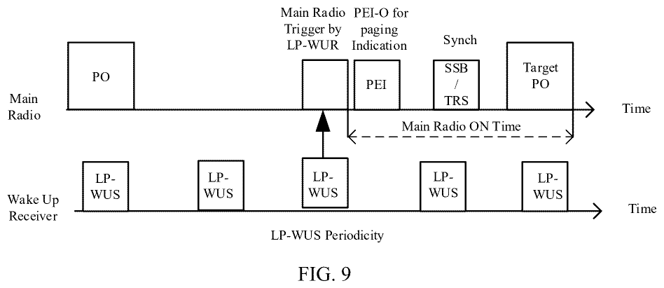

FIG. 9 is a schematic diagram illustrating an example of LP-WUS with shorter periodicity according to an embodiment of the present disclosure. The LP-WUS with shorter periodicity allow the UE LP-WUR to trigger the main radio near to the PEI location or paging PDCCH location in time domain which reduces the ON time of the main radio of UE as shown in FIG. 9, and thus it reduces the power consumption of the main radio. In addition, the LP-WUS with shorter periodicity will let the LP-WUR of the UE to have more chances of selecting a nearby LP-WUS in time domain to trigger the main radio and thus the chances of miss detection of PEI or paging PDCCH is reduced which results in reducing the latency. However, the LP-WUS with shorter periodicity may increase the network overhead.

### Embodiment 2.2: Configured LP-WUS

This embodiment of the present disclosure proposes that LP-WUS can be configured when a network requires to page a UE in idle/inactive state. In the configured LP-WUS, the LP-WUR of UE may trigger the main radio of UE only when it is triggered by the network in idle/inactive state according to signal design explained in embodiment 1.2.

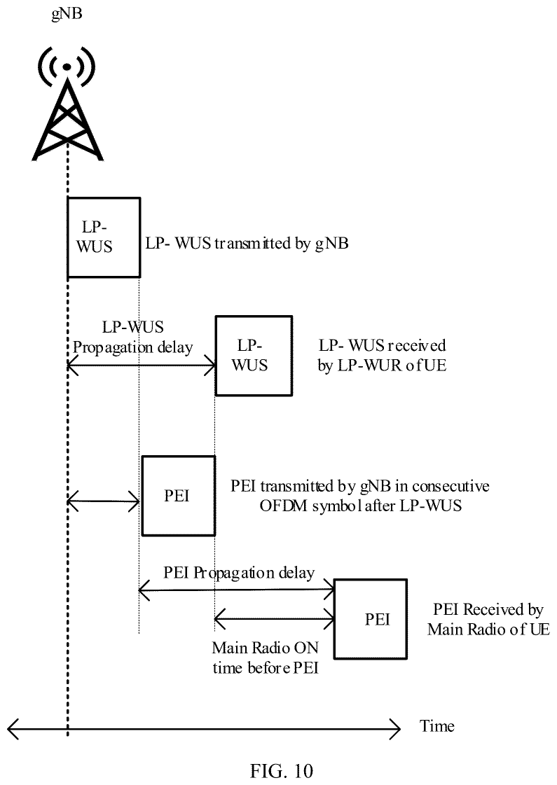

FIG. 10 is a schematic diagram illustrating an illustration of configured LP-WUS to trigger the main radio for PEI monitoring according to an embodiment of the present disclosure. The main advantages of the configured LP-WUS are that it can reduce the main radio ON time in idle/inactive UE as compared to the periodic LP-WUS. For instance, the LP-WUS can be configured in the OFDM symbol before PEI to trigger the main radio of a UE or group of UEs for PEI monitoring. In other words, the transmission of LP-WUS and PEI is in continuous OFDM symbol, which can reduce the ON time of the main radio as shown in FIG. 10.

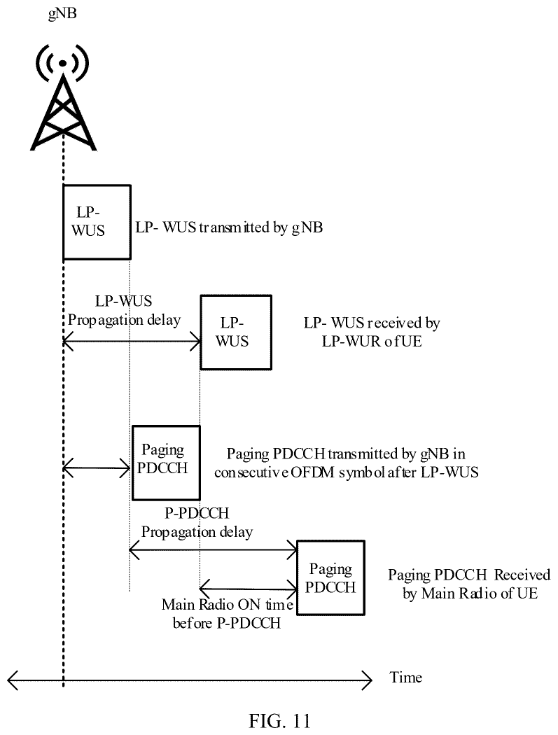

FIG. 11 is a schematic diagram illustrating an illustration of configured LP-WUS to trigger the main radio for paging PDCCH according to an embodiment of the present disclosure. In addition, since the configured LP-WUS is UE specific or UEs group specific according to the signal design of Embodiment 1.2, therefore the configured LP-WUS can be used as an indication to inform the UE or group of UEs to monitor the target paging PDCCH and replace the PEI for paging indication as shown in FIG. 11. The main drawback of the configured LP-WUS is that it requires to include the UE ID or UEs group ID, which increase the LP-WUS overhead and resulting into complex decoding and complex LP-WUR architecture.

### Embodiment 3: LP WUS Monitoring Procedure in Connected State

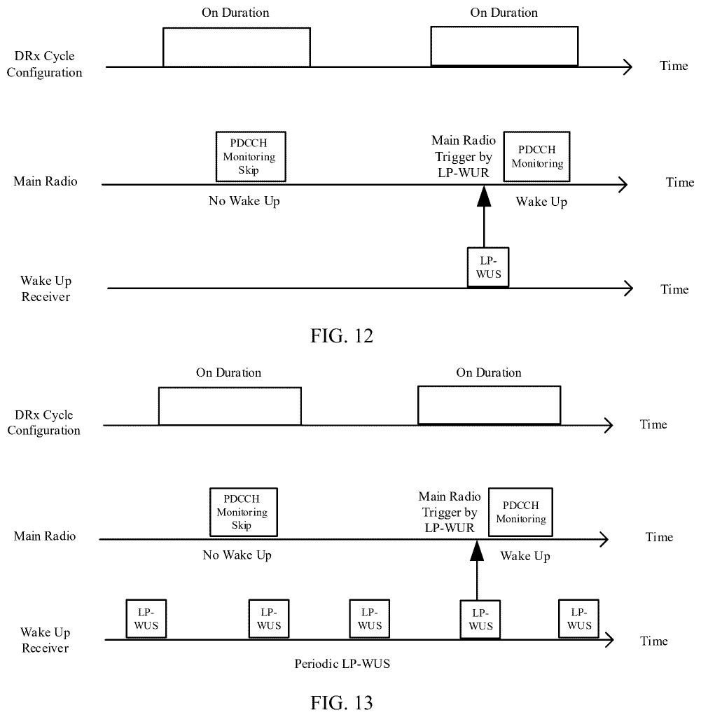

FIG. 12 is a schematic diagram illustrating an illustration of LP-WUS monitoring procedure in connected state according to an embodiment of the present disclosure. This embodiment of the present disclosure discusses the periodic LP-WUS procedure and configured LP-WUS procedure for UEs in RRC connected mode UE. For a UE in RRC connected mode, the main radio is on (possibly in deep/light/micro sleep) while PDCCH monitoring can be performed based on the detection of LP-WUS, e.g., UE does not perform PDCCH monitoring before UE receives LP-WUS as shown in FIG. 12. Note: LP-WUS may replace the functionality of DCI format 2_6 (Rel-16 WUS) to indicate whether to enter DRX on state. LP-WUS can also be used in on-duration to indicate start of PDCCH monitoring.

### Embodiment 3.1: Periodic LP-WUS

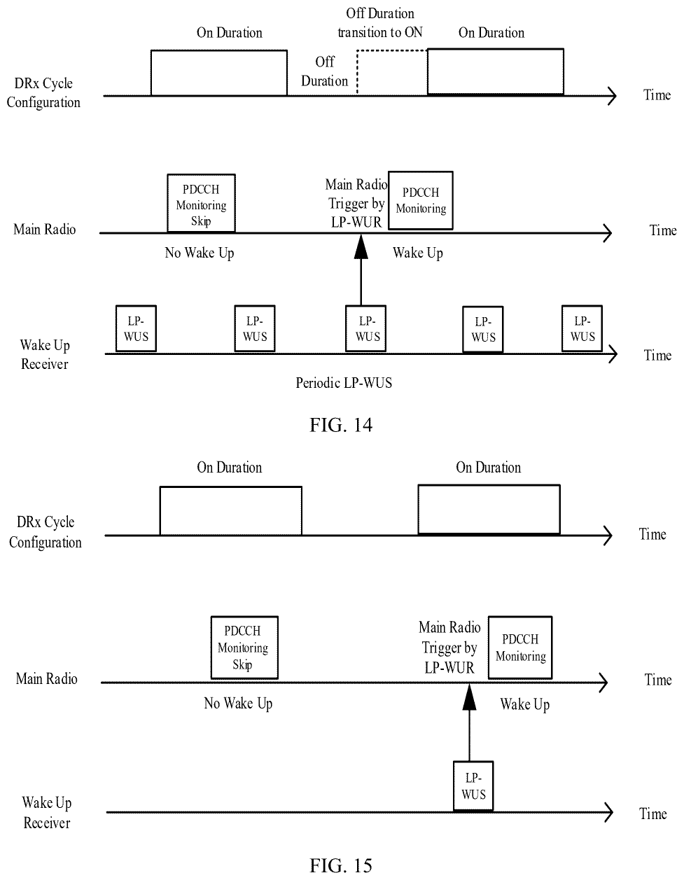

FIG. 13 is a schematic diagram illustrating an illustration of configured LP-WUS trigger the main radio for PDDCH monitoring in DRx on duration according to an embodiment of the present disclosure. This embodiment of the present disclosure proposes that periodic LP-WUS transmitted by the network/gNB can be used by the LP-WUR of UE to trigger the main radio of a UE to performs PDCCH monitoring as shown in FIG. 13. In this embodiment, it is assumed that the LP-WUR of a UE will use the nearby LP-WUS in time domain to trigger the main radio of UE to perform PDCCH monitoring based on the sequence based signal design as explained in embodiment 1.1. FIG. 14 is a schematic diagram illustrating an illustration of periodic LP-WUS to trigger the main radio in DRx off Duration according to an embodiment of the present disclosure. The periodic LP-WUS can be used to trigger the main radio of UE in both DRx on duration and DRx off duration as shown in FIG. 13 and FIG. 14, respectively. Furthermore, a UE in connected DRx, the PDCCH monitoring may only depends on the LP-WUS. Thus, the main radio of UE will only monitor the PDCCH when it is triggered by the LP-WUS. In this way, the main radio of UE can stay in sleeping mode for long time and thus, it can save power. Using the periodic LP-WUS with shorter periodicity may increase the overhead of the network, however it may reduce the latency of DRx mode to monitor the PDCCH as explained in the above embodiments. In addition, the payload of periodic LP-WUS for connected state and idle/inactive state is the same.

### Embodiment 3.2: Configured LP-WUS

FIG. 15 is a schematic diagram illustrating an illustration of configured LP-WUS to trigger the main radio in DRx on Duration according to an embodiment of the present disclosure. Similar to the configured LP-WUS in RRC idle/inactive state, the LP-WUS in connected state can be used to wake up the main radio to monitor the PDCCH according to the signal design explained in embodiment 1.2 as shown in FIG. 15. The advantage of the configured LP-WUS is that it can reduce the network overhead and configure the LP-WUS near the PDCCH monitoring in time domain when it is required, thus reducing the latency. However, the configured LP-WUS for connected states also requires including the UE ID for which the LP-WUS is transmitted and thus resulting into complex decoding and complicated LP-WUR architecture as explained in the above sections.

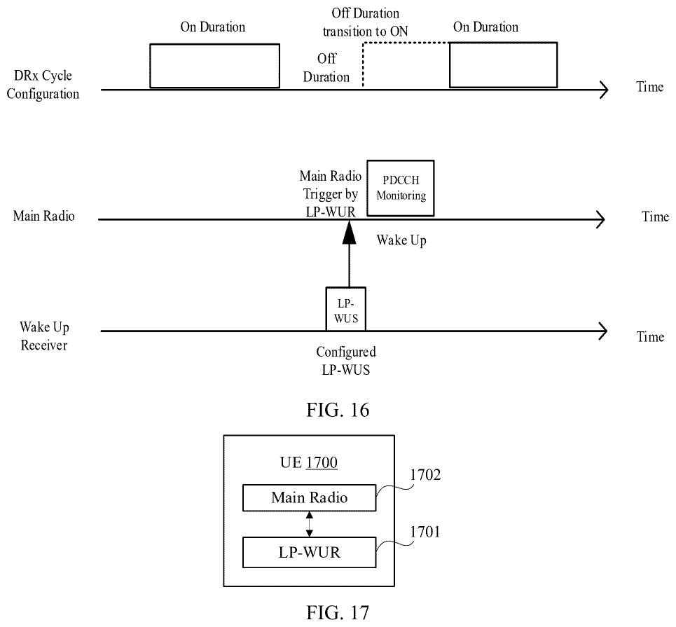

FIG. 16 is a schematic diagram illustrating an illustration of configured LP-WUS to trigger the main radio in DRx off duration according to an embodiment of the present disclosure. In connected state, the configured LP-WUS can also be used to wake up the main radio in DRx off duration to perform the PDCCH monitoring, as shown in FIG. 16. The transition from off duration to on duration can be triggered by the LP-WUS and thus the UE can also perform the PDCCH monitoring in DRx off duration, which can accomplish the requirements of latency sensitive services.

FIG. 17 is a block diagram of a UE for wireless communication according to an embodiment of the present disclosure. The UE 1700 includes a low power wake up receiver (LP-WUR) 1701 and a main radio 1702 coupled to the LP-WUR 1701. The LP-WUR 1701 is configured to wake up the main radio using a LP-WUS, and a signal design of the LP-WUS comprises a sequence based signal design with a physical broadcast channel (PBCH) and/or a UE specific/UEs group specific based signal design of the LP-WUS. In another embodiments, the LP-WUR is configured to wake up the main radio using a periodic LP-WUS and/or a configured LP-WUS. Further, the UE 1700 11 is configured to perform the method in the above some embodiments.

In summary, two different signal designs of LP-WUS are proposed as given below. 1. Sequence based signal design of LP-WUS with physical broadcast channel (PBCH) has proposed to broadcast the LP-WUS to all the UEs under the cell coverage to trigger the main radio for wake up. 2. UE specific and UEs group specific based LP-WUS signal design is proposed, which can achieve the latency requirements of latency critical services. Two alternative working mechanisms of LP-WUS procedure have been proposed for both idle/inactive and connected states as given below. 1. Periodic LP-WUS working mechanism is proposed to reduce the LP-WUS overhead, its decoding complexity and support low cost LP-WUR architecture. 2. Configured LP-WUS working mechanism is proposed to achieve the strict requirements of latency sensitive services. Some embodiments of this disclosure discuss the signal design and procedure of LP-WUS in both idle/inactive state and connected states and have the following one or more advantages: ultra-low power consumption mechanism, low overhead, low latency, and LP-WUS coverage enhancement.

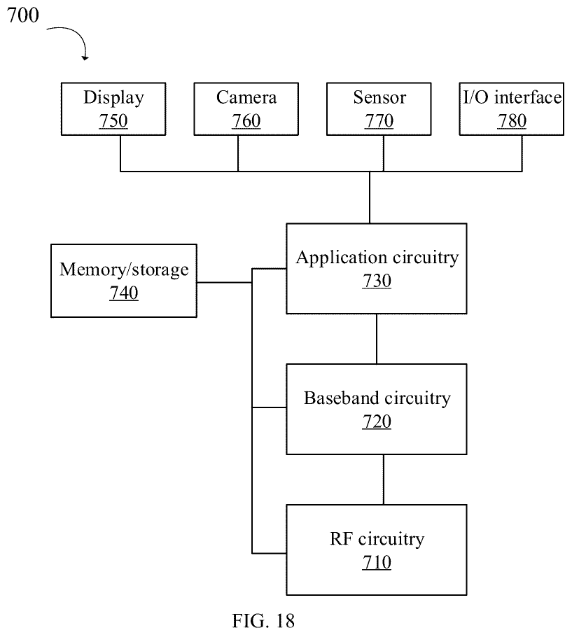

FIG. 18 is a block diagram of an example system 700 for wireless communication according to an embodiment of the present disclosure. Embodiments described herein may be implemented into the system using any suitably configured hardware and/or software. FIG. 18 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method of low power wake up signal (LP-WUS) procedure, comprising:
waking up a main radio of the UE, by a low power wake up receiver (LP-WUR) of a user equipment (UE), using an LP-WUS received from a base station, wherein a signal design of the LP-WUS comprises a sequence based signal design with a physical broadcast channel (PBCH) and/or a UE specific/UEs group specific based sequence signal design of the LP-WUS.

2. The method of LP-WUS procedure according to claim 1, wherein in the sequence based signal design with the PBCH, the LP-WUS is a sequence based LP-WUS, wherein an information is broadcasted to multiple UEs through the sequence based LP-WUS, and an amount of the information transmitted in the sequence based LP-WUS to the multiple UEs have a pre-defined length, where a single bit information is assigned to the UE for wake up function and/or stay in sleeping mode function of the main radio of UE.

3. (canceled)

4. The method of LP-WUS procedure according to claim 1, wherein in the sequence based signal design with the PBCH, the UE detects an allocated information based on its allocated symbols, which is assigned by the base station to the UE when the UE is entering into an LP-WUS mode.

5. The method of LP-WUS procedure according to claim 1, wherein in the UE specific/UEs group specific based sequence signal design of the LP-WUS, the LP-WUS is a UE specific or UEs group specific based LP-WUS, and the UE specific/UEs group specific based LP-WUS is configured to the UE or a group of UEs.

6. The method of LP-WUS procedure according to claim 5, wherein the signal design comprises a low power synchronization signal (LP-SS), the WUS message part, and the payload, the LP-SS synchronizes the LP-WUR before receiving a WUS message part, the WUS message part comprises a bit trigger information for the UE or the group of UEs and a payload comprising a UE identifier (ID) or a UE group ID for which the LP-WUS is transmitted.

7. The method of LP-WUS procedure according to claim 5, wherein the UE specific/UEs group specific based LP-WUS is transmitted only to the UEs which need to wake up, and a single bit information is assigned to the UE for wake up function and/or stay in sleeping mode function of the main radio of UE.

8. The method of LP-WUS procedure according to claim 1, wherein when the main radio of UE is in a radio resource control (RRC) idle/inactive state, a transmission is initiated by the base station to the UE through a paging occasion, and the LP-WUS is used as a trigger before the paging occasion, to activate the main radio of the UE or a group of UEs to wake up for monitoring of the paging occasion.

9. The method of LP-WUS procedure according to claim 8, wherein a periodic LP-WUS transmitted by the base station is received [used] by the LP-WUR of UE to trigger the main radio of the UE for paging monitoring or the LP-WUS is configured in specific occasion is received by the LP-WUR to trigger the main radio of the UE to wake up and monitor paging occasion.

10. The method of LP-WUS procedure according to claim 9, wherein the UE or a group of UEs uses the LP-WUS to trigger the main radio according to the sequence based signal design with the PBCH, and the LP-WUR of the UE or the group of UEs uses the periodic LP-WUS to trigger main radios of UEs only when a paging early indication (PEI) or a paging physical downlink control channel (PDCCH) for specific UEs is transmitted by the base station.

11. The method of LP-WUS procedure according to claim 9, wherein the periodic LP-WUS is not UE specific or UEs group specific and the LP-WUS is transmitted by the base station in a cell or the LP-WUS is transmitted in different beams direction.

12. The method of LP-WUS procedure according to claim 9, wherein a periodicity of the periodic LP-WUS is defined in a range of {5, 10, 20, 40, 80, 160} milliseconds according to a periodicity of the 5G new radio (NR) SS burst.

13. The method of LP-WUS procedure according to claim 9, wherein the LP-WUR of the UE uses the LP-WUS to trigger the main radio which is near to the PEI in time domain.

14. The method of LP-WUS procedure according to claim 9, wherein a configured LP-WUS is used as an indication to inform the UE or the group of UEs to monitor a target paging PDCCH and replace the PEI for paging indication.

15. The method of LP-WUS procedure according to claim 1, wherein when the UE is in an RRC connected state, the main radio is in light/micro sleep while a PDCCH monitoring is performed based on the detection of LP-WUS.

16. The method of LP-WUS procedure according to claim 15, wherein the LP-WUS is used to indicate the UE to enter a discontinuous reception (DRX) on state, and/or the LP-WUS is used in on-duration to indicate the UE a start of the PDCCH monitoring.

17. The method of LP-WUS procedure according to claim 15, wherein the UE or a group of UEs receives the periodic LP-WUS to trigger the main radio according to the sequence based signal design with the PBCH, and the LP-WUR of the UE or the group of UEs uses the periodic LP-WUS to trigger main radios of UEs and indicates to enter a DRX on state to monitor a physical downlink control channel (PDCCH) in DRx on duration and/or DRx off duration.

18. The method of LP-WUS procedure according to claim 15, wherein the UE or a group of UEs receives an LP-WUS configuration in a specific occasion to trigger the main radio according to the LP-WUS signal design of UE specific or UEs group specific, and the LP-WUR of the UE or the group of UEs uses the configured LP-WUS to trigger the main radios of UEs and indicates to enter a DRX on state to monitor a physical downlink control channel (PDCCH) in DRx on duration and/or DRx off duration.

19. A user equipment (UE), comprising:
a low power wake up receiver (LP-WUR) and a main radio coupled to the LP-WUR, wherein the LP-WUR is configured to wake up the main radio using an LP-WUS received from a base station, wherein a signal design of the LP-WUS comprises a sequence based signal design with a physical broadcast channel (PBCH) and/or a UE specific/UEs group specific based sequence signal design of the LP-WUS.

20. A user equipment (UE), comprising:
a low power wake up receiver (LP-WUR) and a main radio coupled to the LP-WUR, wherein the LP-WUR is configured to wake up the main radio using a periodic LP-WUS and/or a configured LP-WUS received from a base station.

21-26. (canceled)
